(19) United States
(12) Patent Application Publication
(10) Pub. No.: US 2023/0035720 A1
(43) Pub. Date: Feb. 2, 2023

(54) Large-dimension, flexible, ultrathin high-conductivity polymer-based composite solid-state electrolyte membrane

(71) Applicant: Solid Energies Inc., Santa Ana, CA (US)

(72) Inventors: Zhigang Lin, Santa Ana, CA (US); Tianyu Meng, Santa Ana, CA (US)

(21) Appl. No.: 17/390,685

(22) Filed: Jul. 30, 2021

(51) Int. Cl. H01M 50/403; H01M 50/446; H01M 50/491; H01M 50/46; H01M 50/211

(52) U.S. Cl. CPC H01M 50/403; H01M 50/446; H01M 50/491; H01M 50/46; H01M 50/211

(57) ABSTRACT

Fabricating a composite solid-state electrolyte (SSE) membrane by infiltrating a porous polymer substrate with a mixture which comprises: (i) polymer precursor, (ii) ceramic nanoparticles with diameters that range from 10 to 2000 nm, (iii) plasticizer and (iv) lithium salt. Curing the mixture yields a solid-state electrolyte which is formed within pores of the substrate. A continuous roll-to-roll system for manufacturing of large-dimension, flexible, ultrathin, high ionic conductivity (SSE) membrane advances a porous polymer substrate through a coating module, multifunctional module for post-treatment curing and calendar unit. The SSE membrane is used in all solid-state lithium-ion electrochemical pouch cells. The SSE membrane exhibits high ionic conductivity over wide temperature range, especially high value in low temperature (−40° C.).

### FIELD OF THE INVENTION

The present invention is generally related to techniques for mass production of large-dimension, flexible, ultrathin, high ionic conductivity polymer-ceramic composite solid-state electrolyte membranes which are used in electrochemical devices such as all solid-state lithium-ion electrochemical cells and batteries.

### BACKGROUND INFORMATION

Non-aqueous lithium electrochemical cells typically include an anode, a lithium electrolyte prepared from a lithium salt dissolved in organic solvents, and a cathode of an electrochemically active material. Organic solvents are added to solvate the lithium salt which provides mobile ions. During the electrochemical discharge process lithium-ions are transported through the electrolyte from the anode to the cathode. As lithium-ions are taken up by the cathode, there is a simultaneous release of electrical energy.

Solid-state electrolytes (SSE) can replace conventional organic liquid electrolytes, which are generally flammable and toxic. Conventional electrode materials and lithium metal anodes can be employed with a SSE. Lithium anodes have high inherent high capacities (C) which increase the cell voltage (V) and thereby improves the energy density of the battery (E=VC). There are two critical challenges to achieving high performance batteries using SSE: (1) low ionic conductivities of many SSE, and (2) the low mechanical strengths of electrolyte materials do not adequately prevent Li dendrite growth. SSE which are being explored are typically inorganic-based (depending on the lattice structure, they are garnet, perovskite, glass-ceramics etc.) and polymer-based. Solid polymer electrolytes can be manufactured by relatively simple, inexpensive techniques whereas fabricating solid inorganic electrolytes with well-defined compositions or lattice structures requires high temperature processes. Due to the high degree of coordination between Li ions and the polymer chain in sold-state polymer electrolytes, the chain-assisted Li⁺ transport mechanism is less robust at room temperature or below the melting temperature of the polymer. The attendant poor ionic conductivity is attributed to interference with Li ion transport. The addition of plasticizers to the solid-state polymer-based electrolyte improves the polymer chain mobility at room temperature which results in an increase in the ionic conductivity, but the plasticizers also reduce the mechanical strength of the solid-state polymer-based electrolyte.

So-called all-solid-state batteries contain exclusively solid materials, and in particular solid-state electrolytes, in contrast to conventional batteries containing liquid electrolytes. One of the main concerns of current all solid-state lithium-ion batteries (ASSLiB) is the poor contact between solid electrolyte and electrodes. The high contact resistance causes low-rate capability and poor cycling stability. With solid polymer electrolytes, lithium dendrites, which develop as an electrochemical cell undergoes charging and discharging cycles, can penetrate through the ‘plasticizer-softened’ polymer electrolytes to short circuit the cell.

### SUMMARY OF THE INVENTION

The present invention is based, in part, on the development of a high ionic conductivity composite solid-state electrolyte membrane that is formed by infusing a porous polymer substrate (or separator) with an electrolyte mixture and curing the mixture. In a preferred embodiment, the porous polymer substrate comprises a large sheet or web that is continuously infused and cured with the electrolyte mixture. The porous polymer substrate serves as a framework to hold and support the electrolyte mixture during post-treatment.

In one aspect, the invention is directed to a roll-to-roll system for fabricating a composite solid-state electrolyte (SSE) membrane that comprises: a continuous source of a sheet of porous substrate which moves in a machine direction; a first coater that is configured to apply a first coat of a first solid electrolyte precursor mixture onto a first surface of the sheet of porous substrate; and a first module, located downstream of the first coater, comprising a first source of ultra-violet radiation and a first source of convection heat. The process produces a flexible, ultrathin, high ionic conductivity composite SSE membrane that can be used in all solid-state electrochemical pouch cells.

In preferred embodiments, the roll-to-roll system includes slot-die coating modules that are configured to coat SSE precursor solutions on both sides of a porous separator membrane substrate. Alternatively, the roll-to-roll system includes doctor blade coating systems that are configured to coat SSE precursor solutions onto a porous separator membrane.

In a preferred embodiment, the roll-to-roll system includes multifunctional modules that are configured to post-treat the precursor solutions after being coated onto the porous separator membrane. The module can effectuate UV crosslinking and solvent evaporating or thermal crosslinking. The solid electrolyte precursor mixture preferably includes: (i) a polymer matrix or precursors thereof, (ii) ceramic nanoparticles with diameters that range from 10 to 2000 nm, (iii) a lithium salt, (iv) a plasticizer.

In further aspect, the invention is directed to a composite solid-state electrolyte (SSE) membrane that includes a porous substrate that is a polymer network, ceramic nanoparticles with diameters that range from 10 to 2000 nm, lithium salt, and plasticizer distributed throughout the porous substrate. The porous substrate is preferably made of a polymer that is different from that of the polymer network. The SSE membrane is hybrid, ceramic-polymer nanocomposite material that typically exhibits high ionic conductivity over a wide temperature window (−40° C. to 90° C.) and excellent chemical/electrochemical stability with respect to the electrodes. The SSE has an amorphous structure and large dielectric constant environment that is favorable for lithium-ion dissociation and polymer chain-assisted ion conduction. It can be used as an electrolyte layer or integrated or added into an electrode layer to form a composite electrode. No liquid organic solvent is required with the composite electrode.

### BRIEF DESCRIPTION OF THE DRAWINGS

FIG. 1 is an industrial scale roll-to-roll manufacturing line for producing SSE membranes.

FIG. 2 is a slot-die coating apparatus;

FIGS. 3A and 3B are cross sectional and prospective views of a doctor blade coating apparatus;

FIG. 4 is a multi-functional module that is configured for post-treatment UV crosslinking and thermal solvent evaporating and thermal crosslinking;

FIG. 5 shows a procedure for making poly(ethylene glycol) diacrylate (PEGDA) based SSE membranes that requires UV crosslinking;

FIG. 6 shows a procedure for making poly(vinylidene fluoride-co-hexafluoropropylene) P(VDF-HFP) based SSE membrane that requires thermal treatment;

FIG. 7 depicts the composition of a solid electrolyte;

FIGS. 8A and 8B are graphs of ionic conductivity vs. temperature for a PEGDA-based solid electrolyte and for a P(VDF-HFP)-based solid electrolyte, respectively;

FIG. 9A shows the multiple structures of a pouch cell;

FIGS. 9B and 9C are perspective and side views of a packaged assembled pouch cell;

FIG. 10 is a process for producing all solid-state lithium-ion battery pouch cells; and

FIGS. 11A and 11B are charge-discharge and cycling stability profiles, respectively, for all solid-state lithium-ion battery pouch cells.

### DETAILED DESCRIPTION OF THE INVENTION

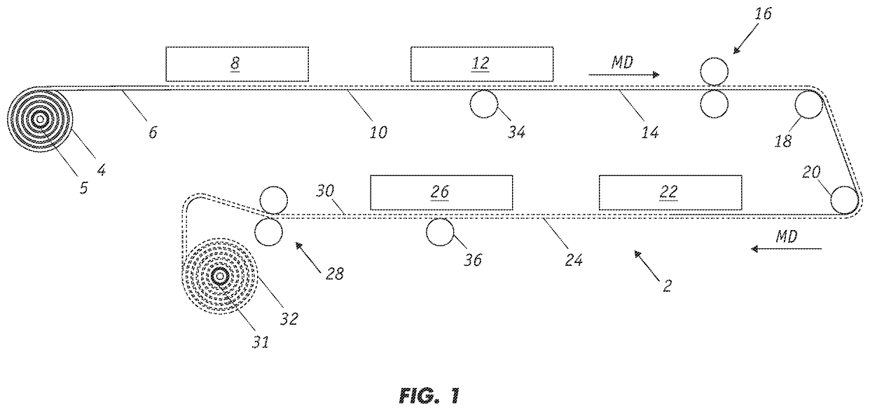

The invention is directed a roll-to-roll manufacturing system for large-size, flexible and ultra-thin composite SSE membranes which are particularly suited for fabricating all solid-state lithium-ion electrochemical cells and batteries. FIG. 1 illustrates a system 2 for manufacturing a hybrid polymer-ceramic composite solid electrolyte membrane on a web or sheet of substrate. The substrate preferably consists of a porous plastic material that can serve as a separator membrane, such as porous polyethylene (PE), porous polypropylene (PP), and PE and PP composite multi-layer materials. The porous plastic material typically has a porosity of 30% to 70% and preferably 45% to 60%; pore size (or average diameter) typically of 0.01 μm to 0.3 μm and preferably 0.02 μm to 0.15 μm. The thickness of the porous plastic material is typically 10 μm to 50 μm and preferably 15 μm to 30 μm. The porous plastic material is commercially available in large rolls with widths that range from 50 mm to 300 mm and longer.

A roll 4 of the porous plastic material is unwound by an unwinder 5 and supplies a continuous sheet 6 that is advanced in the machine direction (MD) by a plurality of rollers 34, 36. The sheet 6 is coated on the top (first) surface with a layer of polymeric-ceramic electrolyte slurry by coater 8 to produce coated sheet 10. The amount of slurry applied is sufficient to infiltrate into approximately halfway into the sheet 6. A dual-functional module 12 exposes the coated sheet 10 to convection heat to remove excess solvent from the electrolyte slurry. Where necessary, the module 12 directs ultra-violet radiation into the electrolyte slurry to cross-link polymers therein to form a polymer network that is uniformly distributed throughout the pores of the porous plastic material Sheet 14 which comprises a polymeric-ceramic composite solid electrolyte formed within the porous plastic material passes through the dual rollers of a calendar 16 to produce smooth solid electrolyte with a uniform thickness along the width in the cross direction, which is perpendicular to the MD.

Turning rollers 18, 20 maneuver sheet 14 so that the second (uncoated) side of the porous polymer material is on top. A layer of polymeric-ceramic electrolyte slurry is applied thereon by coater 22 to produce coated sheet 24 which is passed through a dual-functional module 26 which exposes the coated sheet 24 to convection heat and where necessary, to ultra-violet radiation. Sheet 30 which comprises a polymeric-ceramic composite solid electrolyte distributed throughout pores of the porous plastic material passes through the dual rollers of a calendar 30 to yield a flexible composite SSE membrane which includes a porous substrate that is a polymer network, ceramic nanoparticles, lithium salt, and plasticizer distributed throughout the porous substrate. The composite SSE membrane preferably has a thin electrolyte upper and lower electrolyte layer, with each layer comprising a polymer network, ceramic nanoparticles, lithium salt, and plasticizer but without the substrate. That is, the thin electrolyte layers protrude from the planar surfaces of the composite SSE membrane. A rewinder 31 takes up the composite SSE membrane to form roll 32. The total thickness of the flexible SSE membrane is typically 30 μm to 300 μm and preferably 40 μm to 180 μm and when present the upper and lower electrolyte layers each is typically 10 μm to 120 μm and preferably 15 μm to 80 μm in thickness as part of the total thickness. The porous plastic substrate typically comprises 30% to 70% and preferably 45% to 60% by weight of the entire composite SSE membrane with the remainder being consisting of the solid-state electrolyte.

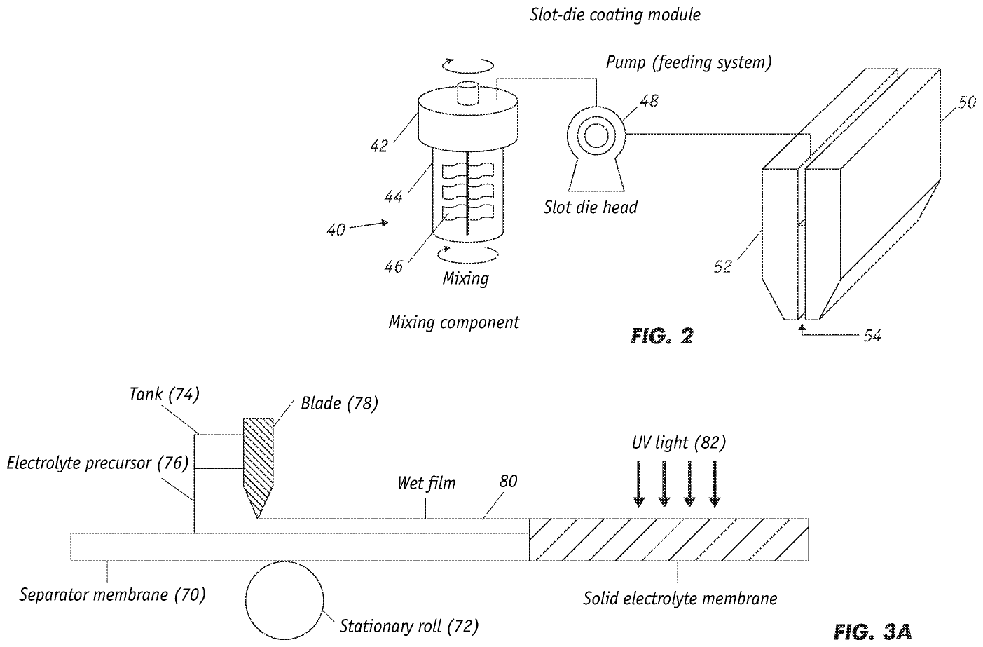

FIG. 2 is a slot-die coating apparatus 40 that can be used as coater 8 and/or 22 of FIG. 1. The apparatus 40 includes a mixer for the electrolyte slurry comprising a container equipped with paddles 46 and a motor 42. A vacuum pump 48 continuous supplies the slurry into the head of a slot die coater that includes first and second bodies 50, 52 which define a reservoir or storage chamber having a lower discharge port 54 through which the slurry of controlled thickness is applied onto a sheet.

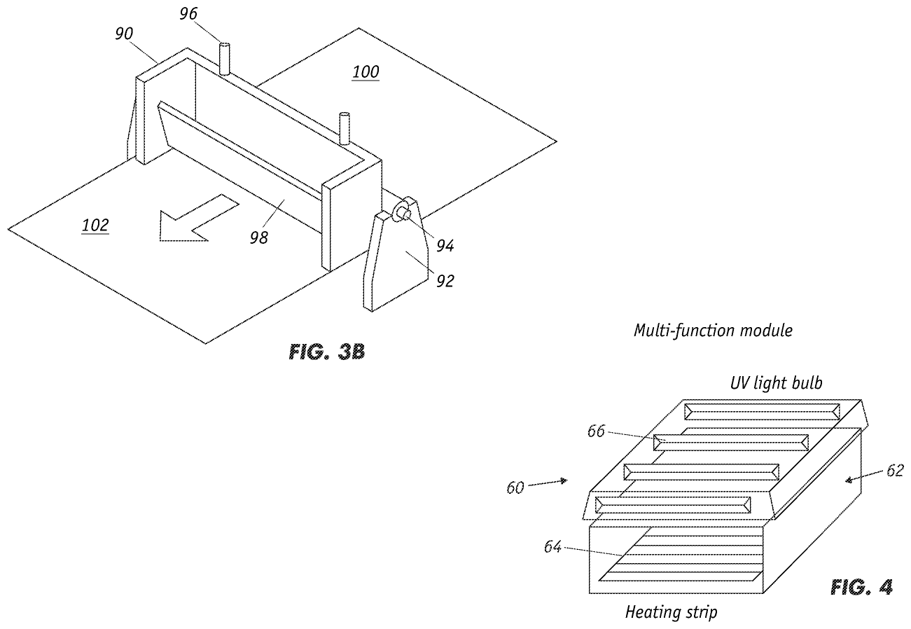

FIG. 3A depicts a doctor blade coating apparatus that can be used as coater 8 and/or 22 of FIG. 1. An electrolyte precursor mixture 76 from tank 74 is discharged through a opening defined by blade 78 onto a separator membrane 70 that is supported by stationary roll 72. The coated polymer-ceramic wet film 80 is exposed to UV irradiation crosslink process to yield a solid-state polymer-ceramic electrolyte 84.

FIG. 3B depicts a perspective view of doctor blade coating apparatus which includes a blade head 90, thickness adjusting knobs 96, and slurry feeding sheet 98. In operation, an uncoated membrane 100 which is supported on a platform travels under the blade. Rotating the thickness adjusting knobs 96 adjusts the desire thickness for printing. Prepared slurry is poured in the space between slurry feeding sheet 98 and blade head 90. The blade can be pushed by push rod 94 which is positioned on push rod stand 92. The push rod 94 is electric powered and moves through straight direction, and its speed can be adjusted. After coating, the coated membrane 102 is obtained.

FIG. 4 depicts multi-functional module 60 which can be used as module 12 and/or 26 of FIG. 1 for post-coating treatment. The module 60 includes a housing that supports a plurality of UV light bulbs 66 and a plurality of heating strips 64. The UV light bulbs preferably radiate UV light with a wavelength of 365 nm to 410 nm to initiate UV crosslink specific polymers in the electrolyte slurry. The heating strips removes solvent from the electrolyte slurry by evaporation and can thermal-crosslink selected polymers use in the slurry. Thus module 60 can effectuate single UV crosslinking, single solvent evaporating and thermal crosslink, or both UV and thermal treatment. For example, poly(ethylene glycol diacrylate) (PEGDA) needs to be crosslinked after coating on separator membrane, and poly(vinylidene fluoride-co-hexafluoropropylene) (P(VDF-HFP)) and polyethylene oxide (PEO) need to be dried after coating on separator membrane.

The polymeric-ceramic electrolyte slurry comprises polymer precursors, lithium salt, ceramic nanoparticles and plasticizers. Preferred polymer precursors include, for example, ethylene oxide, ethylene glycol diacrylate, and acrylonitrile. These polymer precursors from poly (ethylene oxide) (PEO), poly (ethylene glycol diacrylate) (PEGDA), poly(acrylonitrile) (PAN), poly(vinylidene fluoride-co-hexafluoropropylene) P(VDF-HFP), respectively. The polymer precursors typically comprise 10 to 50 wt % and polymeric matrix, which is derived from the polymer precursors, typically comprises 30 to 95 wt % of the subsequent solid electrolyte formed within the porous plastic substrate. A preferred polymer matrix is PEGDA which is derived by in-situ UV-polymerization using phenylbis(2,4,6-trimethylbenzoyl) phosphine oxide, or IRGACURE 819, as the initiator. Another preferred polymer matrix is P(VDF-HFP), which is generally used for high-voltage (˜5V) battery cell.

The lithium salt is any lithium salt that is suitable for use in a non-aqueous solid-state electrolyte. Preferred lithium salts include, for example, LiC₂F₆NO₄S₂ (LiTFSI), LiClO₄, and LiPF₆. The lithium salt preferably comprises 20 to 60 wt % of the polymeric-ceramic electrolyte slurry. A preferred lithium salt comprises a mixture of lithium salts that includes lithium bis(oxalato)borate or LiB(C₂O₄)₂ (LiBoB), which serves as a lithium salt enhancer, to improve ion transport within solid electrolyte that is formed within the porous plastic substrate. Due to low solubility or miscibility of LiBoB, only a small amount of LiBoB should be added into the polymer-ceramic electrolyte slurry. When employed, the weight ratio of LiBoB to solid electrolyte formed within the porous plastic substrate is about 0.4-0.6 wt %.

The ceramic nanoparticles are preferably AlₓLi₇₋ₓLa₃Zr_{1.75}Ta_{0.25}O₁₂ wherein x ranges from 0 to 0.85 (LLZO) and have diameters that range from 10 nm to 2000 nm. The LLZO preferably comprises 5 to 70 wt % of the polymeric-ceramic electrolyte slurry and of the solid electrolyte that is formed within the porous plastic substrate. Incorporating LLZO into a polymer solid electrolyte produces a solid electrolyte with enhanced structure integrity and high ionic conductivity.

The LLZO is synthesized by mixing stoichiometric amounts of starting powders including LiOH H₂O, La₂O₃, ZrO₂, Al₂O₃ and Ta₂O₅ and milling the mixture via high energy ball milling in ethanol media for 8-12 hrs. Zirconia balls (average diameters of 5 mm) balls at a ball-to-powder weight ratio of about 20:1 and about 360 rpm milling speed. After milling, the collected slurry is dried (80° C., 2-3 hrs), crushed, and sieved (through a 200 mesh), and calcined at about 900° C. for 6 hours to fully decompose LiOH. The as-calcined powders are then ball-milled again in ethanol for 6-12 hrs. Planetary ball mill was used, followed by drying process. The dried powders were pressed into pellets with diameters of about 9.5 mm at about 300 MPa, and then sintered with a temperature range from 800° C. to 1150° C. for about 4 hrs to obtain particles with size from 100 nm to 2000 nm. Both calcination and sintering processes are carried out with samples in alumina crucibles covered by alumina lids, and the pellets are embedded in the prepared powder in order to mitigate losses of volatile components and accidental contamination. As is apparent, when synthesizing LLZO of the formula Li₇La₃Zr_{1.75}Ta_{0.25}O₁₂, that is when x is 0, no Al₂O₃ is used.

A feature of the invention is that the size of LLZO nanoparticles can be tuned by controlling temperature of synthesis. The calcine temperature determines the particle sizes of LLZO. Generally, high calcined temperature and long calcined time produce larger size LLZO particles. It has been demonstrated that a calcine temperature of about: (i) 950° C., (ii) 1000° C., and (iii) 1050° C. yields LLZO nanoparticles with diameters of about 100 to 600 nm, 1000 to 1200 nm, and 1 to 2 μm, respectively.

The plasticizer is an aprotic compound that serves as a liquid medium in which the polymer precursors are polymerized to form a polymer matrix. The plasticizer comprises dimethyl sulfoxide (DMSO), succinonitrile (SCN), glutaronitrile (GN), ethylene carbonate (EC), propylene carbonate (PC), sulfolane (SL) and mixtures thereof. In particular, the solid electrolyte can contain essentially a single plasticizer. The plasticizer preferably comprises 10 to 60 wt % of the polymeric-ceramic electrolyte slurry and that solid electrolyte formed within the porous plastic substrate.

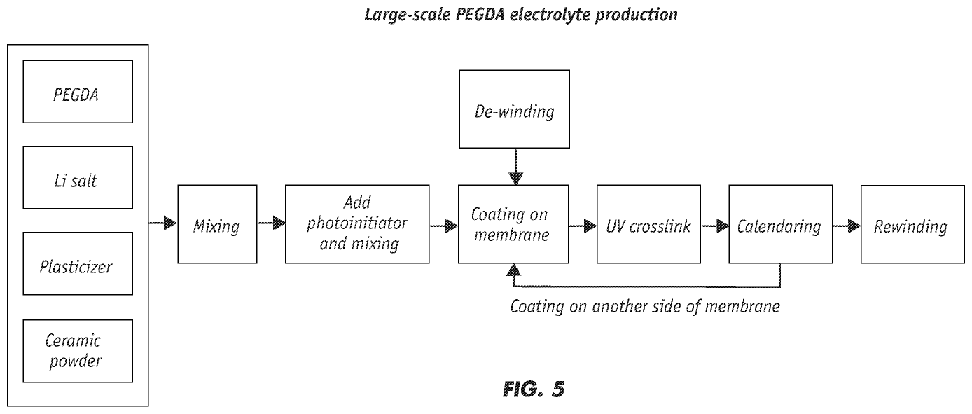

The flow chart in FIG. 5 illustrates a process for producing UV crosslinkable polymer-ceramic composite SSEs using PEGDA to form the polymeric matrix. The components of polymer-ceramic composite SSE, which comprise polymer or monomer, Li salt, plasticizer, and ceramic powder are mixed into a precursor solution. Then, a photoinitiator is added into the solution and mixed before coating onto a separator membrane. A roll of separator membrane is installed onto a support roll before being de-winded and installed through the roll-to-roll system 2 shown in FIG. 1. Both sides of the sheet of separator membrane undergoes coating with precursor solution; UV crosslinking of the precursor solution creates a polymeric network; and calendaring produces a sheet of flatten and compact double-sided coated separator membrane that is rewound. The polymer-based SSE penetrates into the separator membrane which is bonded to the top and bottom SSE layers so as to form a complete (or unitary) composite electrolyte sheet.

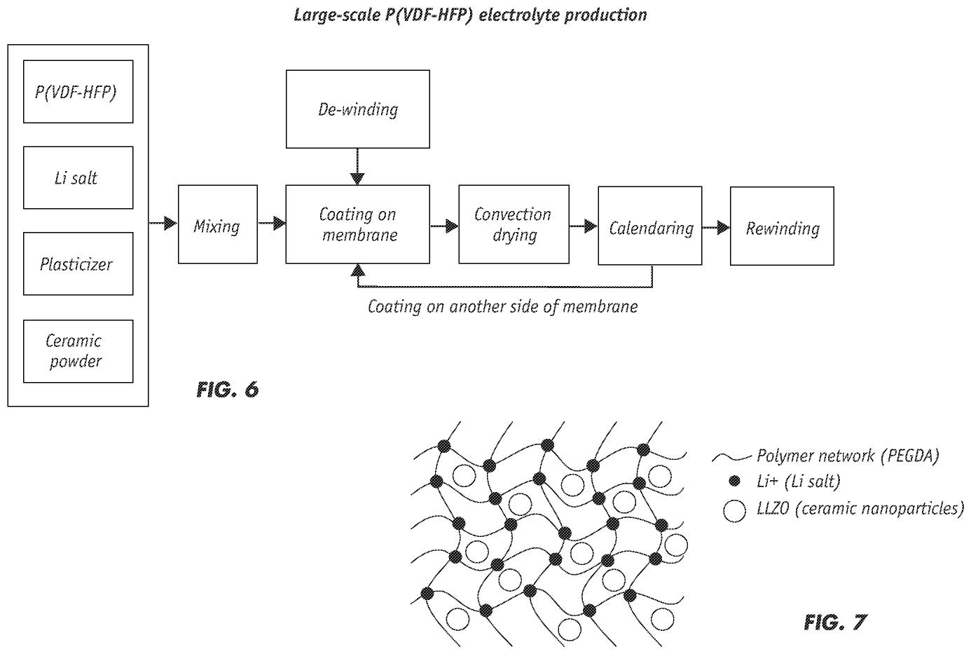

The flow chart in FIG. 6 illustrates a process for producing polymer-ceramic composites electrolyte which requires thermal treatment to remove excess solvent or thermal crosslinking. P(VDF-HFP) is used for the polymer matrix. The components of polymer-ceramic composite solid electrolyte, which comprises polymer matrix or monomer, Li salt, plasticizer, and ceramic powder are mixed into solution. A roll of separator membrane is installed onto a support roll before being de-winded and installed through the roll-to-roll system 2 shown in FIG. 1. Both sides of the sheet of separator membrane undergoes coating with precursor solution, thermal treatment for solvent evaporating or polymer network thermal crosslinking, and calendaring to produce a sheet of flatten and compact double-sided coated separator membrane that is rewound. The polymer-based SSE penetrates into the separator membrane which is bonded to the top and bottom SSE layers so as to form a complete (or unitary) composite electrolyte sheet.

The composite SSE membrane of the present invention exhibits ionic conductivity of greater than 1×10⁻⁵ S/cm (at room temperature of 20° C.) and has a large electrochemical window of up to 5.8V (at room temperature). In addition, it has a wide use temperature with a thermally stable temperature of up to 150° C. and a glass transition temperature of less than −60° C. Finally, the composite SSE membrane shows low interfacial resistance, good compatibility with both lithium metal and cathode materials, and enhanced mechanical strength with a Young's modulus that exceeds 50 MPa.

During the fabrication process of large-scale electrolyte, certain types of monomer or polymer precursors, such as PEGDA, will be polymerized or crosslinked, which could establish polymer network and have strong interaction between Li salt and ceramic nanoparticles, as presented in FIG. 7. Other polymers, such as P(VDF-HFP) and PEO, will dried without crosslinking.

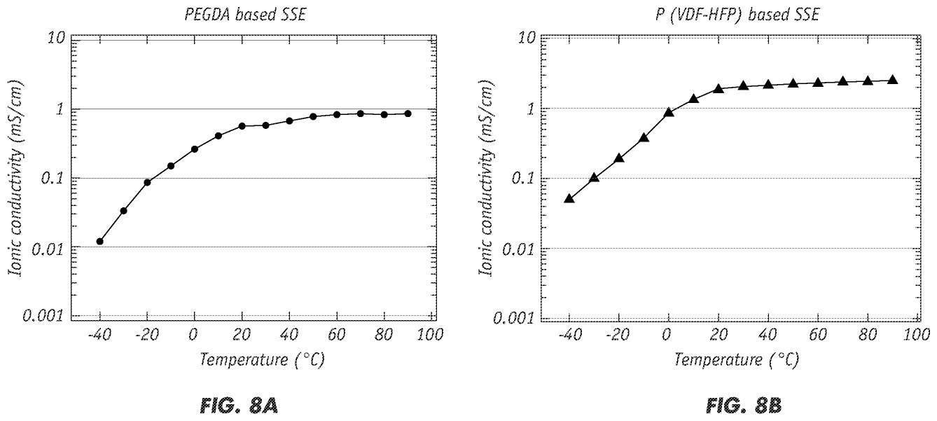

FIG. 8A and FIG. 8B present ionic conductivity of PEGDA-LLZO based and P(VDF-HFP)-LLZO based composite SSE membrane, respectively. Different polymer-ceramic composite SSE membranes are developed to use in different voltage operation. PEGDA is generally used for cells with operating voltage lower than 4.0V, while P(VDF-HFP) is generally used for cells with operating voltage greater than 4.0V. SSE is stable and can serves as ion conductor over wide temperature of −40° C. to 90° C. SSE membrane presented in FIG. 8A contains 10 wt % to 50 wt % PEGDA, 20 wt % to 60 wt % LiTFSL, 10 wt % to 60 wt % EC, and 5 to 60 wt % LLZO. The SSE exhibits ionic conductivity of above 0.6 mS/cm for temperature range of 20° C. to 90° C. In the low temperature range of −40° C. to 10° C., the SSE membrane exhibits ionic conductivity of above 0.01 mS/cm. SSE membrane presented in FIG. 8B contains 10 wt % to 50 wt % P(VDF-HFP), 20 wt % to 60 wt % LiTFSI, 10 wt % to 60 wt % sulfoalne, and 5 to 60 wt % LLZO. For the P(VDF-HFP) based electrolyte, SSE exhibits ionic conductivity of above 1 mS/cm for temperature range of 20° C. to 90° C. In the low temperature range of −40° C. to 10° C., the SSE membrane exhibits ionic conductivity of greater than 0.05 mS/cm.

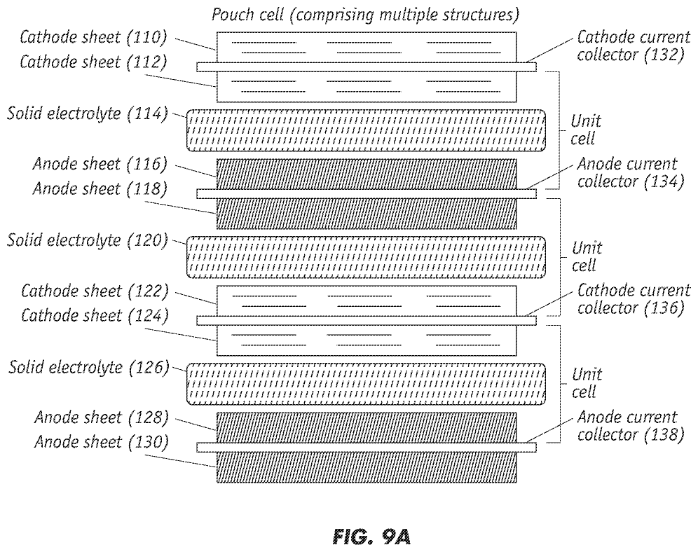

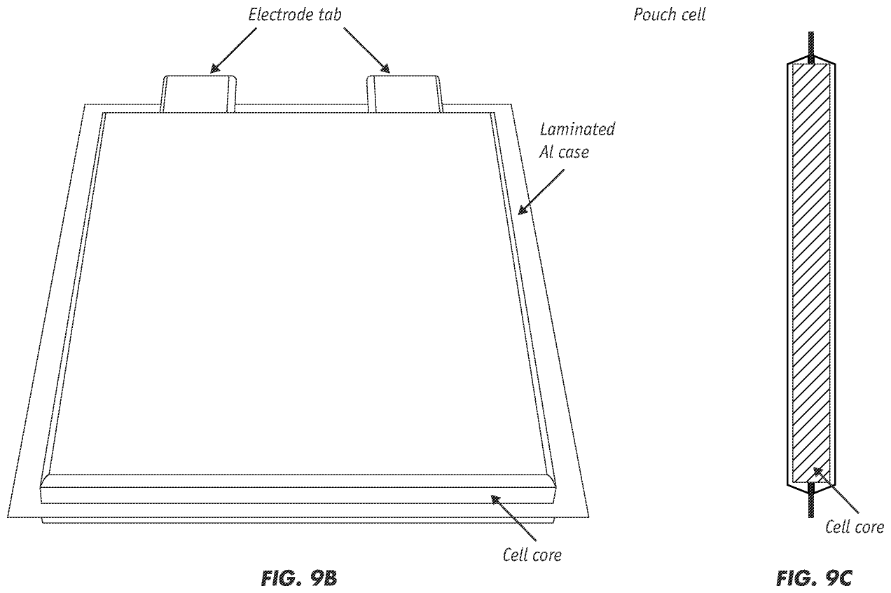

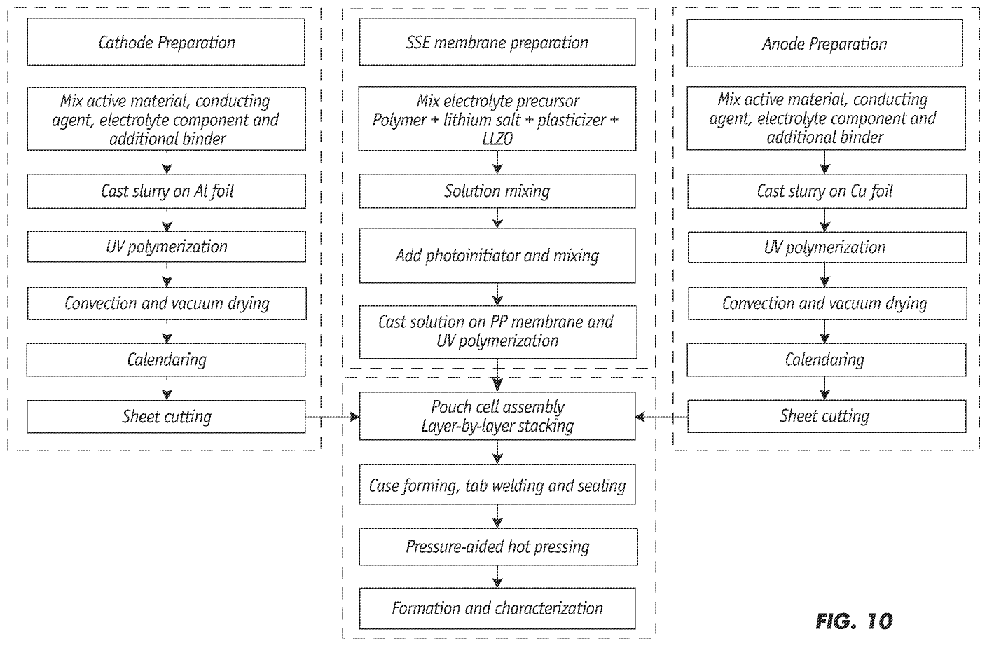

The polymer-ceramic composite SSE membrane is particularly suited for use in all solid-state electrochemical cells in the form of pouch cell and battery. A “pouch cell” type battery as shown in FIG. 9A includes a plurality of unit cells. In this configuration, the pouch cell includes cathode sheets 110 and 112 that are connected to cathode current collector 132, anode sheets 116 and 118 that are connected to anode current collector 134, cathode sheets 122 and 124 that are connected to cathode current collector 136, and anode sheets 128 and 130 that are connected to anode current collector 138. Solid-state electrolytes 114, 120, and 126, which are made of the composite SSE membrane, are positioned between the anodes and cathodes.

After the cathode, the electrolyte and the anode are stacked and the cell is assembled, the entire structure is calendared to ensure intimate contact between the layers High temperature is also applied during calendaring process as the polymer becomes “soft” at high temperatures so that it becomes easier and more effective to compress the structure and create compact contacts between polymer and electrode. The temperature is selected based on the formulation of the solid electrolyte which ranges from 60° C. to 180° C.

The pouch cell as shown in FIGS. 9A and 9B comprises a soft shell which is generally laminated aluminum case that encloses the cell core consisting of one or more unit cells. Anode and cathode tabs are welded to the anode and cathode current collectors, respectively. A battery refers to two or more electrochemical cells electrically interconnected to in an appropriate series/parallel arrangement to provide the required operating voltage and current levels. Electrochemical cells can be stacked into batteries of various configurations including pouch cells. Lithium-ion electrochemical cells and batteries can exhibit 3.6V/2.5 Ah energy and powder performance typically in the range of 2.5 to 5.0 vols with an electric charge of 2.5 to 10 amp-hour, preferred cells and batteries can operate at 3.6V with 2.5 Ah.

FIG. 10 presents a method of making pouch cells which can be implemented in four steps: (i) cathode preparation, (ii) anode preparation, (iii) electrolyte preparation, and (iv) cell stacking/assembly. To prepare cathode sheets, the components are mixed in N-methyl-2-pyrrolidone (NMP) solvent and stirred overnight. Then, the slurry is coated on an Al foil by doctor blade coating, followed by UV crosslinking for 10 minutes. Thereafter, the sheets are transferred to an oven and dried at 80° C. for 2 hours and then 150° C. under vacuum overnight. Finally, cathode sheets are calendared and cut. To prepare anode sheets, the components are mixed in NMP solvent and stirred. overnight. Then, the slurry is coated on a Cu foil by doctor blade coating, followed by UV crosslinking for 10 minutes. Thereafter, the sheets are transferred to an oven and dried at 80° C. for 2 hours and then 150° C. under vacuum for overnight. Finally, anode sheets are calendared and cut. To prepare SSE membrane, a precursor solution is prepared by mixing the components and stirring for 1 hour. Then, the solution is coated on a polypropylene (PP) membrane, followed by UV crosslinking for 10 minutes. After the first layer SSE is coated, the membrane is calendared to flatten the surface. Then, the solution is coated on another side of PP membrane, followed by UV crosslinking for 10 minutes. After the second layer SSE is coated, the membrane is calendared again. Finally, the SSE membrane is winded to form an SSE roll and the roll is ready for layer stacking.

Once the electrolyte, cathode, and anode layers are made, cathode sheets, solid electrolyte and anode sheets are stacked layer-by-layer by Z-folding stacking format. Then, the cell core is welded and sealed in laminated aluminum case. Finally, the pouch cell is pressed by pneumatic hot press machine, where the pouch cell pressed with a pressure of 400 psi and temperature of 150° C. for 10 minutes.

In the exemplary pouch cell, SSE membrane positioned between anode and cathode comprises 12.5 wt % polymer matrix that is derived from PEGDA, 37.5 wt % EC, 33 wt % LiTFSI, 17 wt % Al_{0.15}Li_{0.85}La₃Zr_{1.75}Ta_{0.25}O₁₂ with diameters that range from 10 to 2000 nm. The SSE membrane is fabricated by using roll-to-roll manufacture system presented in FIG. 2. The cathode comprises 4 wt % carbon black, 90 wt % LFP. 1.67 wt % LiTFSI, 0.82 wt % Al_{0.15}Li_{0.85}La₃Zr_{1.75}Ta_{0.25}O₁₂ with diameters that range from 10 to 2000 nm, 1.88 wt % EC, 0.63 wt % polymer matrix that is derived from PEGDA and 4 wt % PVDF. The anode comprises 4 wt % carbon black, 92 wt % graphite, 1.67 wt % LiTFSI, 0.82 wt % Al_{0.15}Li_{0.85}La₃Zr_{1.75}Ta_{0.25}O₁₂ with diameters that range from 10 to 2000 nm, 1.88 wt % EC, 0.63 wt % polymer matrix that is derived from PEGDA and 4 wt % PVDF. The dimension of pouch cell is 6.3 cm×4.7 cm×9.3 cm. Pouch cell is assembled generally in accordance with procedure set forth in FIG. 10.

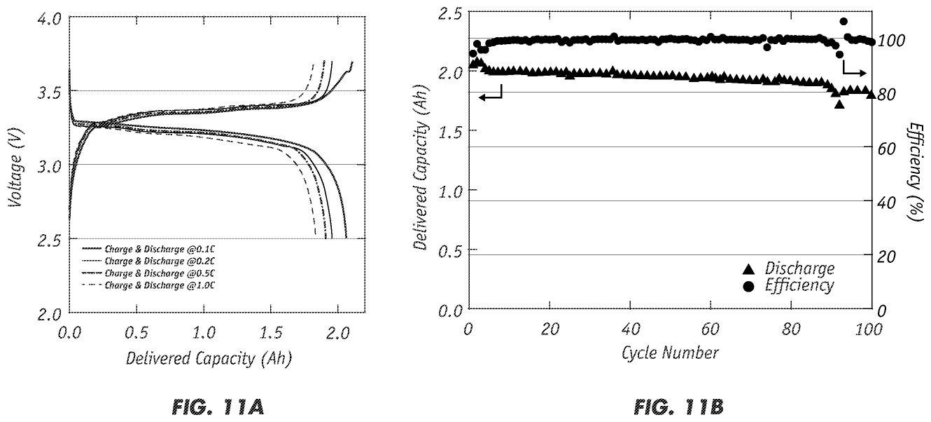

The optimized mass energy density and volume energy density of all solid-state pouch cell prototype could reach over 200 Wh/kg and 400 Wh/L. FIG. 11A shows rate performance of standard 2 Ah pouch cell. When pouch cell is charged and discharged at 0.1C, 0.2C, 0.5C and 1.0C, the delivered capacity is around 2.06 Ah, 1.99 Ah, 1.93 Ah and 1.92 Ah, respectively, indicating good and stable rate performance. FIG. 11B shows cycling stability of pouch cell which is charged and discharged at 0.2C. During test, the delivered capacity drops continuously but maintained a stable value between 1.9 Ah and 1.8 Ah. After over 100 cycles, the delivered capacity still retains 90% of the original value.

The foregoing has described the principles, preferred embodiment and modes of operation of the present invention. However, the invention should not be construed as limited to the particular embodiments discussed. Instead, the above-described embodiments should be regarded as illustrative rather than restrictive, and it should be appreciated that variations may be made in those embodiments by workers skilled in the art without departing from the scope of the present invention as defined by the following claims.

1. A roll-to-roll system for fabricating a composite solid-state electrolyte (SSE) membrane that comprises:
a continuous source of a sheet of porous substrate which moves in a machine direction wherein the porous substrate comprises a porous polymer membrane having a porosity of 30 to 70%;
a first coater that is configured to apply a first coat of a first solid electrolyte precursor mixture onto a first surface of the sheet of porous substrate; and
a first module, located downstream of the first coater, comprising a first source of ultra-violet radiation and a first source of convection heat.

2. The system of claim 1 wherein the first coater comprises a (i) first slot-die coater or (ii) a first applicator having a doctor blade configured to dispense the first coat.

3. The system of claim 1 wherein the first solid electrolyte precursor mixture comprises: (i) a first polymer precursor, (ii) first ceramic nanoparticles with diameters that range from 10 to 2000 nm, (iii) a first plasticizer and (iv) a first lithium salt.

4. The system of claim 3 wherein the first ceramic nanoparticles are selected from the group consisting of ceramic materials having the basic formula Li₇La₃Zr₂O₁₂ (LLZO) and derivatives thereof wherein at least one of Al, Ta, or Nb is substituted in Zr sites of the Li₇La₃Zr₂O₁₂.

5. The system of claim 1 wherein the first polymer precursor comprises (i) crosslinked PEGDA or (ii) p(VDF-HFP).

6. (canceled)

7. The system of claim 1 further comprising a second coater that is configured to apply a second coat of a second solid electrolyte precursor mixture onto a second surface of the sheet of porous substrate; and a second module, located downstream of the second coater, comprising a second source of ultra-violet radiation and a second source of convection heat.

8. The system of claim 7 wherein the second solid electrolyte precursor mixture comprises: (i) a second polymer precursor, (ii) second ceramic nanoparticles with diameters that range from 10 to 2000 nm, (iii) a second plasticizer and (iv) a second lithium salt.

9. The system of claim 8 wherein the second ceramic nanoparticles are selected from the group consisting of ceramic materials having the basic formula Li₇La₃Zr₂O₁₂ (LLZO) and derivatives thereof wherein at least one of Al, Ta, or Nb is substituted in Zr sites of the Li₇La₃Zr₂O₁₂.

10. The system of claim 8 wherein the second polymer precursor comprises (i) PEGDA or (ii) p(VDF-HFP).

11-22. (canceled)

23. The system of claim 7 wherein the second coater comprises a (i) second slot-die coater or (ii) a second applicator having a doctor blade configured to dispense the second coat.

24. The system of claim 1 wherein the first solid electrolyte precursor mixture infiltrates into pores of the porous substrate.

25. The system of claim 1 wherein the porous substrate comprises polyethylene, polypropylene or a composite of polyethylene and polypropylene.

26. The system of claim 7 wherein the second solid electrolyte precursor mixture infiltrates into pores of the porous substrate.
